(19) United States
(12) Patent Application Publication
(10) Pub. No.: US 2021/0040379 A1
(43) Pub. Date: Feb. 11, 2021

(54) METHOD FOR PREPARING LOW-DENSITY PROPPANT BY TAKING OIL-BASED MUD WASTES AS RAW MATERIALS

(71) Applicant: Southwest Petroleum University, Chengdu (CN)

(72) Inventors: Zhaozhong Yang, Chengdu (CN); Zijia Liao, Chengdu (CN); Qi Xue, Chengdu (CN); Xiaogang Li, Chengdu (CN); Xiaodong Bai, Chengdu (CN)

(73) Assignee: Southwest Petroleum University

(21) Appl. No.: 17/076,838

(22) Filed: Oct. 22, 2020

(51) Int. Cl. C09K 8/80; C04B 33/132; C04B 33/13; C04B 33/32

(52) U.S. Cl. CPC C09K 8/80; C04B 33/1321; C04B 33/32; C04B 33/131; C04B 33/1305

(57) ABSTRACT

The present invention discloses a method for preparing a low-density proppant by taking oil-based mud wastes as raw materials. The method includes following steps: S1, determining content of oils, silicon oxide, alumina and water in the oil-based mud wastes; S2, adding a viscosity modifier, a framework material and a pore-forming agent into oil-based mud wastes so as to obtain mixed slurry; S3, performing ball milling on mixed slurry to form powder, granulating and drying the powder, and forming a proppant pellet billet; S4, performing dehydrogenation pre-sintering on the pellet billet, and performing carbide reaction pre-sintering; and S5, performing final sintering in a natural gas protective atmosphere, thereby obtaining the low-density proppant that takes silicon carbide as the framework material. In the present invention, the low-density proppant is prepared by taking the oil-based mud wastes produced in a drilling process as the raw materials, thereby recycling the oil-based mud wastes.

### TECHNICAL FIELD

The present invention relates to the technical field of oil-gas field development, and more particularly to a method for preparing a low-density proppant by taking oil-based mud wastes as raw materials.

### BACKGROUND

With the introduction of a national shale gas energy strategy, exploration and extraction amounts of shale gas have been increased progressively year by year.

Hydraulic fracturing serving as a necessary means of shale gas extraction is widely applied. During hydraulic fracturing, to prevent closure of fractured fractures under the action of crustal stress, a ceramsite proppant is often used. The ceramsite proppant is excellent in compressive property and can effectively support underground fracturing fractures. However, density of the ceramsite proppant is generally high. Existing researches have shown that, high density of the proppant may cause high settling velocity of the proppant during fracturing, thereby affecting migration capacity of the proppant and further affecting effective layout of the proppant. To realize the effective layout of the proppant is the key of forming artificial fractures having high fracture flow capacities and increasing a fracturing reformation effect. Therefore, it is necessary to develop a proppant with a low-density function.

In another aspect, lots of liquid and solid wastes are discharged in the shale gas drilling process. Harmful constituents of the wastes mainly include heavy metal ions, petroleum hydrocarbons and organic matters. The ecological environment is severely affected by the wastes. Particularly oil-based mud wastes have reached standards for hazardous wastes. Thus, innocent treatment and resource utilization of the wastes are urgent important environmental protection problems.

### SUMMARY

A purpose of the present invention is to provide a method for preparing a low-density proppant by taking oil-based mud wastes as raw materials.

The method for preparing the low-density proppant by taking oil-based mud wastes as raw materials provided by the present invention has a main technical route as follows: by taking oil-based mud wastes (also called oil-based mud rock shoulders) produced in a drilling process as raw materials, on the basis of fully analyzing the composition and content of oil-based mud, a viscosity modifier, a necessary proppant sintered framework material and a pore-forming agent are added, subjected to ball milling and mixed into powder, the powder is subjected to pressure spray granulation at a normal temperature and dried to prepare a proppant pellet billet; and the proppant pellet billet is subjected to dehydrogenation reaction and carbide reaction pre-sintering in a vacuum reaction furnace, and finally subjected to final sintering in a protective atmosphere, thereby obtaining the low-density proppant that takes silicon carbide as a framework material.

The above method includes specific steps:

S1, determining content of oils, silicon oxide, alumina and water in residual oil-based mud wastes, wherein the oils include white oil, heavy oil and other mineral oil;

S2, adding a viscosity modifier, a framework material and a pore-forming agent into the oil-based mud wastes according to the content of the various components in the oil-based mud wastes determined in the step S1 so as to obtain mixed slurry,

wherein the viscosity modifier refers to water and BEM-JN acrylic series viscosity reducer and is used for regulating viscosity of the mixed slurry; the framework material is preferably powdery quartz sand and is used for increasing strength of the proppant; the pore-forming agent is preferably powdered borax and has effects of forming pores inside the proppant and lowering density of the proppant; the finally obtained mixed slurry includes the following components in percentage by mass: 15-20% of oils, 60-70% of SiO₂, 0.2-1% of a BEM-JN viscosity reducer, 1-4% of powdered borax and the balance of compounds of elements such as Al, Fe, Ca and Mg and water; kinematic viscosity of the mixed slurry is regulated to be 100-120 mm²/s by the viscosity modifier, the content of the oils depends on initial and later addition of the mud wastes; and SiO₂ is selected from the mud wastes and added quartz sand;

S3, milling the mixed slurry into powder by a wet ball-milling process, wherein more than 85% of the particle size of the powder is in a range of 5-20 μm; granulating the powder by a pressure spray granulation method at a normal temperature; drying the powder, and forming a proppant pellet billet;

S4, performing dehydrogenation pre-sintering on the pellet billet in a vacuum reaction furnace at a pre-sintering temperature of 450-600° C. for 2-4 h; and performing carbide reaction pre-sintering at a pre-sintering temperature of 950-1150° C. for 3-5 h, wherein the dehydrogenation treatment is that C in hydrocarbons is removed to react with SiO₂ so as to produce SiC (carbonization), i.e., dehydrogenation and carbide pre-sintering;

S5, taking natural gas as shielding gas; performing final sintering in a natural gas atmosphere at a calcination temperature of 1500-1650′C; sintering at a constant temperature for 2-4 h; fully completing a solid-phase reaction; and organically combining a material structure of the proppant and hard particles, thereby obtaining the low-density proppant that takes silicon carbide as the framework material. The aim of final sintering is densification.

Compared with the prior art, the present invention has beneficial effects as follows:

The Al, Si, Ca, Mg and compounds thereof, the oil-based components and the like contained in the oil-based mud are all the preparative raw materials of the proppant, and the fracturing proppant is prepared by utilizing the oil-based mud. On one hand, a treatment problem of the oil-based mud wastes is solved; on the other hand, process technology requirements of shale gas extraction can be well met by developing the low-density proppant. Oil in the oil-based mud serves as a carbon source in the low-density proppant. By virtue of an advanced ceramic preparation technology, high-strength carbides are synthesized by the carbon source and silicon, aluminum and other elements so as to replace existing oxide proppant ceramsite. Thus, the low-density proppant that takes the silicon carbide as the framework material is formed. The method becomes a new way to prepare the low-density proppant. The prepared proppant has a particle size of 0.2-1.0 mm, apparent density of 1.8-2.5 g/cm³ and compressive strength of 35-60 MPa.

Other advantages, objectives and features of the present invention will be partially shown by virtue of descriptions below, and will further be partially understood by those skilled in the art by virtue of research and practice of the present invention.

### DETAILED DESCRIPTION

Preferred embodiments of the present invention will be described below. It should be understood that, the preferred embodiments described herein are merely used for describing and explaining the present invention, rather than limiting the present invention.

### Embodiment 1

A method for preparing a low-density proppant by taking oil-based mud wastes as raw materials includes the following steps:

S1, content of oils, silicon oxide, alumina and water in oil-based mud wastes was determined;

S2, water and BEM-JN acrylic series viscosity reducer were quantitatively added to serve as a modifier according to a formula in accordance with test results in the step S1; quartz sand was added to serve as a framework material; borax was added to serve as a pore-forming agent so as to obtain mixed slurry having kinematic viscosity of 100 mm²/s; the mixed slurry included the following components in percentage by mass: 15% of oils, 60% of SiO₂, 0.2% of a BEM-JN viscosity reducer, 1% of powdered borax and the balance of compounds of elements such as Al, Fe, Ca and Mg and water;

S3, the mixed slurry was subjected to wet milling at 200 r/min for 5 h, wherein more than 85% of a particle size of solid-phase mixed powder in the ball-milled slurry powder was 5-20 μm; then, the ball-milled slurry was subjected to pressure spray granulation at a normal temperature by using spray granulation equipment; a proppant pellet billet having a particle size of 0.212-0.425 mm was selected by a standard sampling screen; and the pellet billet was dried at a temperature of 80° C. for 4 h;

S4, the dried pellet billet was subjected to dehydrogenation treatment in a vacuum reaction furnace at 450° C. for 2 h; and the temperature was raised to 950° C. for carrying out a carbide reaction and performing proppant pre-sintering, wherein reaction pre-sintering time was 3 h;

S5, natural gas was introduced into a vacuum sintering furnace to serve as shielding gas; the pre-sintered proppant pellet billet was subjected to final sintering at a sintering temperature of 1500° C. for 2 h, thereby obtaining the low-density proppant that takes silicon carbide as the framework material.

### Embodiment 2

A method for preparing a low-density proppant by taking oil-based mud wastes as raw materials includes the following steps:

S1, content of oils, silicon oxide, alumina and water in oil-based mud wastes was determined;

S2, water and BEM-JN acrylic series viscosity reducer were quantitatively added to serve as a modifier according to a formula in accordance with test results in the step S1; quartz sand was added to serve as a framework material; borax was added to serve as a pore-forming agent so as to obtain mixed slurry having kinematic viscosity of 120 mm²/s; the mixed slurry included the following components in percentage by mass: 20/of oils, 70% of SiO₂, 1% of a BEM-JN viscosity reducer, 4% of powdered borax and the balance of compounds of elements such as Al, Fe, Ca and Mg and water,

S3, the mixed slurry was subjected to wet milling at 200 r/min for 5 h, wherein more than 85% of a particle size of solid-phase mixed powder in the ball-milled slurry powder was 5-20 μm; then, the ball-milled slurry was subjected to pressure spray granulation at a normal temperature by using spray granulation equipment; a proppant pellet billet having a particle size of 0.212-0.425 mm was selected by a standard sampling screen; and the pellet billet was dried at a temperature of 80° C. for 4 h; S4, the dried pellet billet was subjected to dehydrogenation treatment in a vacuum reaction furnace at 600° C. for 4 h; and the temperature was raised to 1100° C. for carrying out a carbide reaction and performing proppant pre-sintering, wherein reaction pre-sintering time was 5 h;

S5, natural gas was introduced into a vacuum sintering furnace to serve as shielding gas; the pre-sintered proppant pellet billet was subjected to final sintering at a sintering temperature of 1600° C. for 4 h, thereby obtaining the low-density proppant that takes silicon carbide as the framework material.

### Embodiment 3

A method for preparing a low-density proppant by taking oil-based mud wastes as raw materials includes the following steps:

S1, content of oils, silicon oxide, alumina and water in residual oil-based mud wastes was determined;

S2, water and BEM-JN acrylic series viscosity reducer were quantitatively added to serve as a modifier according to a formula in accordance with test results in the step S1; quartz sand was added to serve as a framework material; borax was added to serve as a pore-forming agent so as to obtain mixed slurry having kinematic viscosity of 110 mm²/s; the mixed slurry included the following components in percentage by mass: 18% of oils, 65% of SiO₂, 0.6% of a BEM-JN viscosity reducer, 3% of powdered borax and the balance of compounds of elements such as Al, Fe, Ca and Mg and water,

S3, the mixed slurry was subjected to wet milling at 200 r/min for 5 h, wherein more than 85% of a particle size of solid-phase mixed powder in the ball-milled slurry powder was 5-20 μm; the ball-milled slurry was subjected to pressure spray granulation at a normal temperature by using spray granulation equipment; a proppant pellet billet having a particle size of 0.425-0.85 mm was selected by a standard sampling screen; and the pellet billet was dried at a temperature of 80° C. for 4 h;

S4, the dried pellet billet was subjected to dehydrogenation treatment in a vacuum reaction furnace at 600′C for 4 h; and the temperature was raised to 1100° C. for carrying out a carbide reaction and performing proppant pre-sintering, wherein reaction pre-sintering time was 5 h;

S5, natural gas was introduced into a vacuum sintering furnace to serve as shielding gas; the pre-sintered proppant pellet billet was subjected to final sintering at a sintering temperature of 1600° C. for 4 h, thereby obtaining the low-density proppant that takes silicon carbide as the framework material.

The low-density proppant product prepared in Embodiments 1-3 is tested in accordance with Oil and Natural Gas Industry Standard of the People's Republic of China (SY/T 5108-2014). Test results are shown as the following table:

| | Particle size | Apparent | | |
|---|---|---|---|---|
| | distribution | density | 9% breakage | Compressive |
| Proppant | (mm) | (g/cm3) | rate grade | strength |
| Embodiment 1 | 0.212-0.425 | 1.8 | 5K | 35 MPa |
| Embodiment 2 | 0.212-0.425 | 2.3 | 7.5K | 52 MPa |
| Embodiment 3 | 0.425-0.85 | 2.5 | 8.5K | 59 MPa |

To sum up, the present invention provides the method for preparing the low-density proppant by taking oil-based mud wastes for oil and gas drilling (also called oil-based mud rock shoulders) as raw materials. Compared with the traditional proppant, by taking the oil-based mud wastes produced in the drilling process as raw materials, on the basis of fully analyzing the composition and content of oil-based mud, the modifier, the necessary proppant sintered framework and the pore-forming material are added, subjected to ball milling and mixed into powder; the powder is subjected to pressure spray granulation at a normal temperature and dried to prepare a proppant pellet billet; and the proppant pellet billet is subjected to dehydrogenation reaction and carbide reaction pre-sintering in the vacuum reaction furnace, and finally subjected to final sintering in the protective atmosphere, thereby obtaining the low-density high-strength proppant ceramsite that takes silicon carbide as the framework material. The prepared proppant has the particle size of 0.2-1.0 mm, apparent density of 1.8-2.5 g/cm³ and compressive strength of 35-60 MPa. Various indexes of the proppant meet the industrial standard. The proppant can be applied to actual fracturing construction. More importantly, resource utilization of the oil-based mud wastes is realized; waste materials are changed into things of value; and requirements for environmental protection and energy conservation are met.

The above only describes preferred embodiments of the present invention, rather than limits the present invention in any form. Although the present invention has been disclosed in the preferred embodiments above, the embodiments are not used for limiting the present invention. The embodiments can be slightly changed or modified into equivalent embodiments having equivalent changes by those skilled in the art by utilizing the technical contents disclosed above without departing from the scope of the technical solutions of the present invention. However, any simple changes, equivalent changes and modifications made to the embodiments above in accordance with the technical essence of the present invention without departing from the contents of the technical solutions of the present invention shall belong to the scope of the technical solutions of the present invention.

1. A method for preparing a low-density proppant by taking oil-based mud wastes as raw materials, comprising: adding a viscosity modifier, a framework material and a pore-forming agent into the oil-based mud wastes so as to obtain mixed slurry; granulating the mixed slurry to become a pellet billet; performing dehydrogenation pre-sintering and performing carbide reaction pre-sintering on the pellet billet; and finally, calcining the pellet billet at a high temperature, thereby obtaining the low-density proppant.

2. The method for preparing the low-density proppant by taking oil-based mud wastes as raw materials according to claim 1, comprising the following steps:
S1, determining content of oils, silicon oxide, alumina and water in the oil-based mud wastes;
S2, adding the viscosity modifier, the framework material and the pore-forming agent into the oil-based mud wastes so as to obtain mixed slurry;
S3, performing ball milling on the mixed slurry to form powder, granulating and drying the powder, and forming a proppant pellet billet,
S4, performing dehydrogenation pre-sintering on the pellet billet in a vacuum reaction furnace, and performing carbide reaction pre-sintering;
S5, performing final sintering in a natural gas protective atmosphere, thereby obtaining the low-density proppant that takes silicon carbide as the framework material.

3. The method for preparing the low-density proppant by taking oil-based mud wastes as raw materials according to claim 2, wherein the viscosity modifier refers to water and BEM-JN acrylic series viscosity reducer.

4. The method for preparing the low-density proppant by taking oil-based mud wastes as raw materials according to claim 3, wherein the framework material is powdery quartz sand.

5. The method for preparing the low-density proppant by taking oil-based mud wastes as raw materials according to claim 4, wherein the pore-forming agent is powdered borax.

6. The method for preparing the low-density proppant by taking oil-based mud wastes as raw materials according to claim 5, wherein the step S2 comprises: supplementing the viscosity modifier, the framework material and the pore-forming agent into the oil-based mud wastes according to the content of the various components in the oil-based mud wastes determined in the step S iso as to obtain mixed slurry; and the mixed slurry comprises the following components in percentage by mass:
15-20% of oils, 60-70% of SiO₂, 0.2-1% of a BEM-JN viscosity reducer, 1-4% of powdered borax and the balance of compounds of elements such as Al, Fe, Ca and Mg and water.

7. The method for preparing the low-density proppant by taking oil-based mud wastes as raw materials according to claim 6, wherein kinematic viscosity of the mixed slurry is regulated to be 100-120 mm²/s.

8. The method for preparing the low-density proppant by taking oil-based mud wastes as raw materials according to claim 2, wherein the step S3 comprises: milling the mixed slurry into powder by a wet ball-milling process, wherein more than 85% of the particle size of the powder is in a range of 5-20 μm; granulating the powder by pressure spray granulation at a normal temperature; drying the powder; and forming a proppant pellet billet.

9. The method for preparing the low-density proppant by taking oil-based mud wastes as raw materials according to claim 2, wherein, in the step S4, a dehydrogenation pre-sintering temperature is 450-600° C., and reaction time is 2-4 h; and a carbide reaction pre-sintering temperature is 950-1150° C., and pre-sintering time is 3-5 h.

10. The method for preparing the low-density proppant by taking oil-based mud wastes as raw materials according to claim 2, wherein, the step S5 comprises: performing constant temperature sintering at 1500-1650° C. for 2-4 h by taking natural gas as protective gas.
